(19) United States
(12) Patent Application Publication
(10) Pub. No.: US 2013/0282396 A1
(43) Pub. Date: Oct. 24, 2013

(54) SYSTEM AND METHOD FOR DEPLOYING MULTIPLE CLINICAL DECISION SUPPORT MODELS

(71) Applicant: Charles Lagor, Wayland, MA (US)

(72) Inventor: Charles Lagor, Wayland, MA (US)

(73) Assignee: KONINKLIJKE PHILIPS N.V., Eindhoven (NL)

(21) Appl. No.: 13/995,959

(22) PCT Filed: Dec. 15, 2011
(86) PCT No.: PCT/IB11/55706

§ 371 Date: Jun. 20, 2013

Related U.S. Application Data
(60) Provisional application No. 61/424,867, filed on Dec. 20, 2010.

(51) Int. Cl. G06F 19/00

(52) U.S. Cl. CPC G06F 19/3437
USPC 705/2

(57) ABSTRACT

A clinical decision support system (CDSS) (106) provides clinical recommendations to one or more consuming clinical applications (104) based on patient data. The CDSS (106) includes a models database (134) that includes one or more models embodying clinical knowledge. The models are stored using a standardized protocol and each solves a clinical problem. The CDSS (106) further includes a model selection engine (154) that selects one or more of the models relevant to the patient data and a transformation engine (156) that instantiates the selected models. Even more, the CDSS (106) includes a decision logic engine (158) that applies the patient data to the instantiated models to determine solutions to the clinical problems associated with the instantiated models, where the solutions are provided to the consuming clinical applications (104).

The present application relates generally to clinical decision making. It finds particular application in conjunction with clinical decision support systems, and will be described with particular reference thereto. However, it is to be understood that it also finds application in other usage scenarios, and is not necessarily limited to the aforementioned application.

A clinical decision support system (CDSS) is a system that provides one or more of administrators, clinicians, patients, and the like with clinical recommendations that is intelligently filtered and presented at appropriate times. By providing clinical recommendations, CDSSs seek to improve workflows, contribute to better financial outcomes, and ultimately enhance the quality of care. To provide clinical recommendations that helps users, CDSSs typically obtain and analyze patient data using a computer interpretable knowledge base of clinical knowledge specific to a clinical problem. For example, it is contemplated that if a CDSS receives patient data indicating a patient's blood sugar value is 49 mg/dl, the CDSS determines whether the patient associated with the patient data is hypoglycemic through application of the patient data to a computer interpretable rule that states “IF blood sugar <60 mg/dl THEN hypoglycemia”.

CDSS developers typically establish clinical knowledge by one or more of reading medical literature, mining patient data, consulting clinical experts, and the like. To format the clinical knowledge in a computer interpretable form, the CDSS developers model the clinical knowledge using mathematical and/or computational methodologies. For example, the CDSS developers model clinical knowledge using one of a Bayesian network, an artificial neural network, logistic regression, and the like. The choice of methodology depends upon consideration of a number of factors. These factors include the strengths and weaknesses of each methodology, the clinical problem, the availability of training data, the CDSS developers' preferences, and the like.

To have a scalable CDSS that addresses multiple clinical problems, it is desirable to allow the use of multiple methodologies. Multiple methodologies are desirable because, inter alia, some methodologies are best suited for specific clinical problems; some methodologies are the only options given local circumstances (e.g., a lack of training data may leave an expert-trained Bayesian network or Fuzzy Logic model as the only options); two methodologies could solve one clinical problem, where the strengths of one methodology compensate for the weaknesses of the other methodology; and two methodologies could solve one clinical problem, where one is the default approach and the other is the “backup” approach (e.g., if the patient data set for predicting community-acquired pneumonia is complete, use a logistic regression model; otherwise, use a Bayesian network). However, a problem with current CDSSs is that they are not flexible and cannot accommodate multiple mathematical and/or computational methodologies. While it may be sufficient to use one mathematical and/or computational methodology for some CDSSs, for a scalable CDSS this is insufficient.

The present application provides a new and improved systems and methods which overcomes the above-referenced problems and others.

In accordance with one aspect, a clinical decision support system (CDSS) is provided that provides clinical recommendations based on patient data to one or more consuming clinical applications, such as clinical devices, patient information systems, and the like. The CDSS includes a models database that includes one or more models embodying clinical knowledge. The models are stored using a standardized protocol and each solves a clinical problem. The CDSS further includes a model selection engine that selects one or more of the models relevant to the patient data and a transformation engine that instantiates the selected models. Even more, the CDSS includes a decision logic engine that applies the patient data to the instantiated models to determine solutions to the clinical problems associated with the instantiated models, where the solutions are provided to the consuming clinical applications.

In accordance with another aspect, a method of providing clinicians with clinical recommendations based on patient data is provided. Patient data is received and one or more models relevant to the patient data are selected from a models database. The models are stored using a standardized protocol and each solves a clinical problem. The selected models are instantiated and the patient data is applied to the instantiated models to determine solutions to the clinical problems associated with the instantiated models. The solutions are provided to one or more clinicians.

In accordance with another aspect, a medical institution is provided. The medical institution includes one or more clinical data sources and one or more consuming clinical applications that provide patient data to and/or receive clinical recommendations from a clinical decision support system (CDSS). The medical institution further includes a models database that includes one or more models embodying clinical knowledge. The models are stored using a standardized protocol and each solves a clinical problem. The clinical decision support system is operative to: receive patient data from one or more of the clinical data sources; select one or more of the models relevant to the patient data; instantiate the selected models; apply the patient data to the instantiated models to determine solutions to the clinical problems associated with the instantiated models; and provide solutions to one or more of the consuming clinical applications.

One advantage of the present systems and methods resides in the ability to provide a scalable CDSS.

Another advantage resides in the ability to apply the most appropriate mathematical and/or computational methodology in a plug and play fashion in real time.

Another advantage resides in the ability to provide two (or more) mathematical and/or computational methodologies to a clinical problem in real time.

Another advantage resides in the ability to provide existing models in a scalable fashion at design time.

Another advantage resides in the ability to reuse various mathematical and/or computational methodologies in one CDSS.

Another advantage resides in the ability to instantiate a model in real-time using a protocol that defines how the model should be instantiated.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

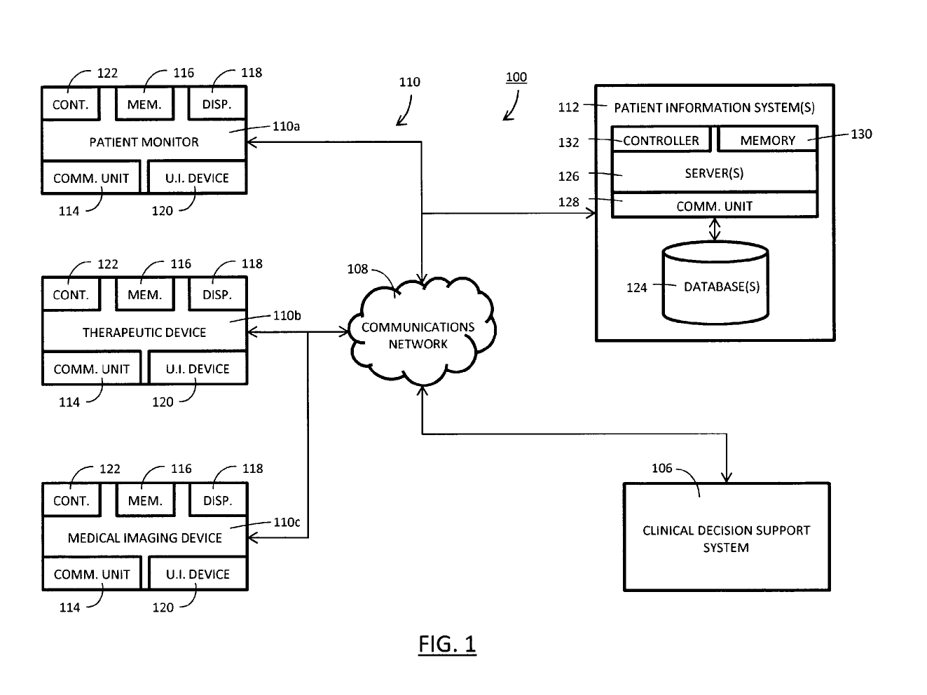

FIG. 1 is a block diagram of an information technology (IT) infrastructure of a medical institution according to aspects of the present disclosure;

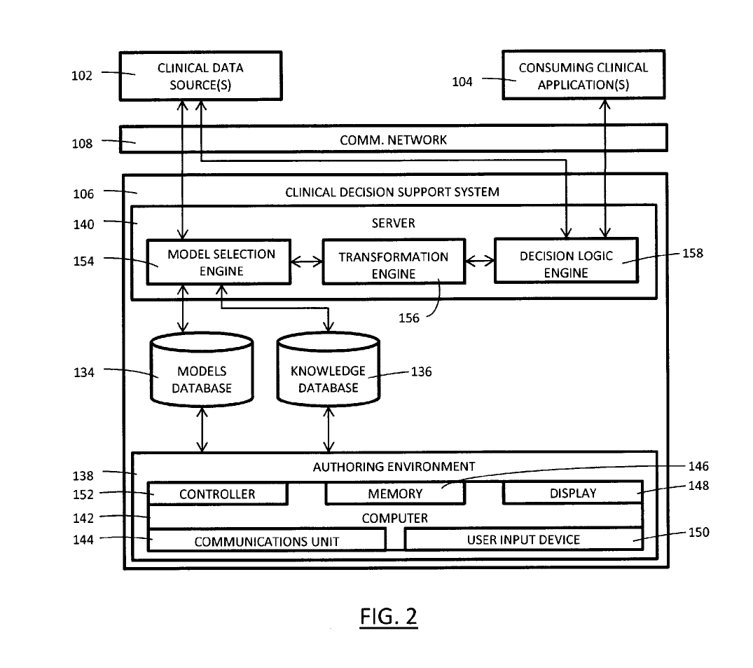

FIG. 2 is a functional view of a clinical decision support system according to aspects of the present disclosure;

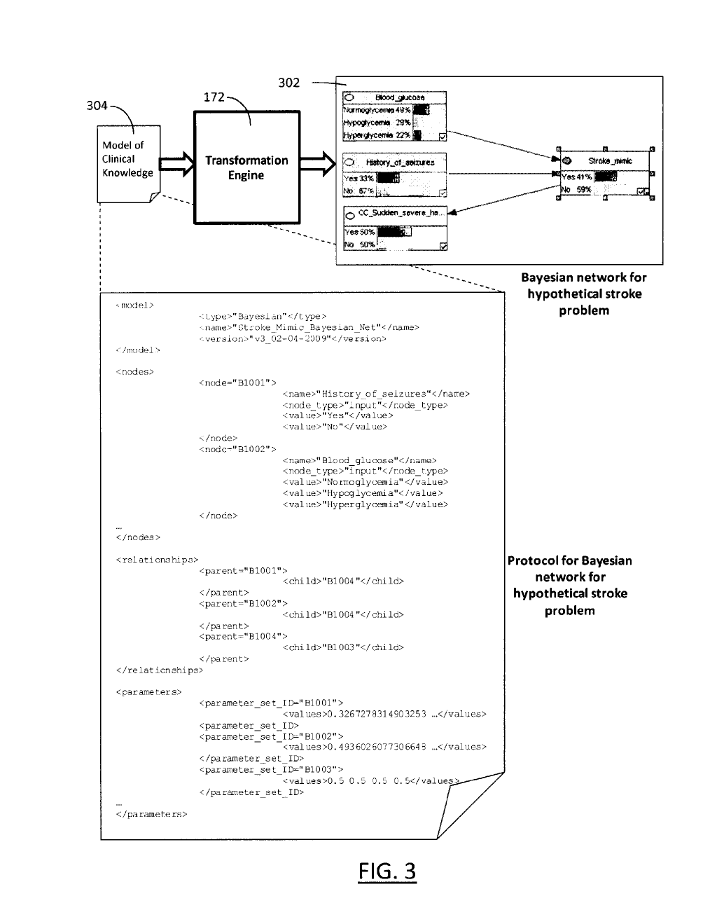

FIG. 3 is a graphical illustration of the instantiation of clinical knowledge modeled using an artificial neural network according to aspects of the present disclosure;

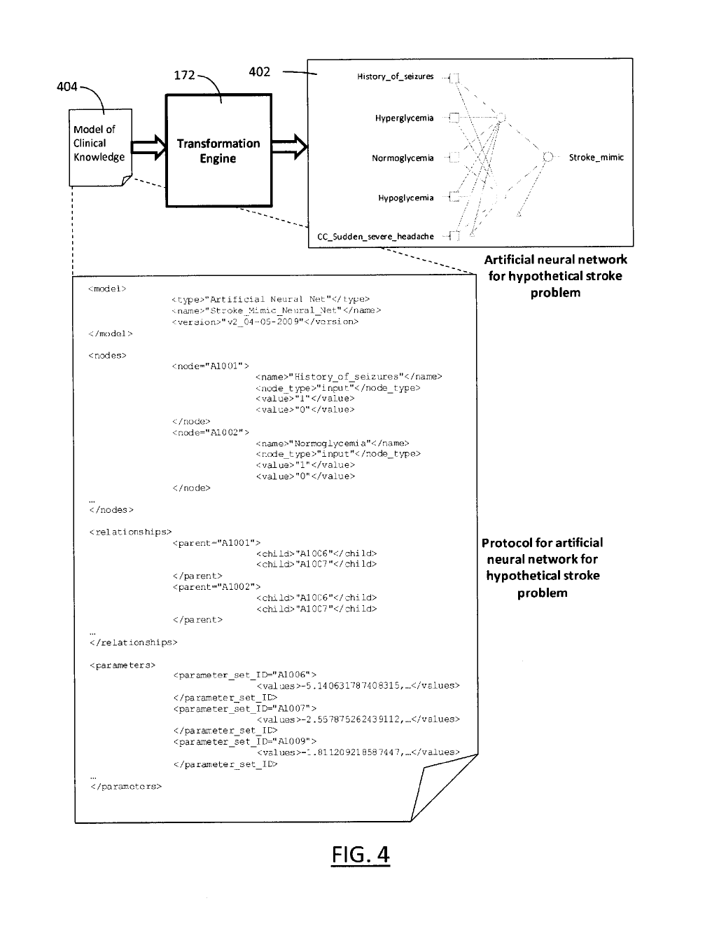

FIG. 4 is a graphical illustration of the instantiation of clinical knowledge modeled using a Bayesian network according to aspects of the present disclosure;

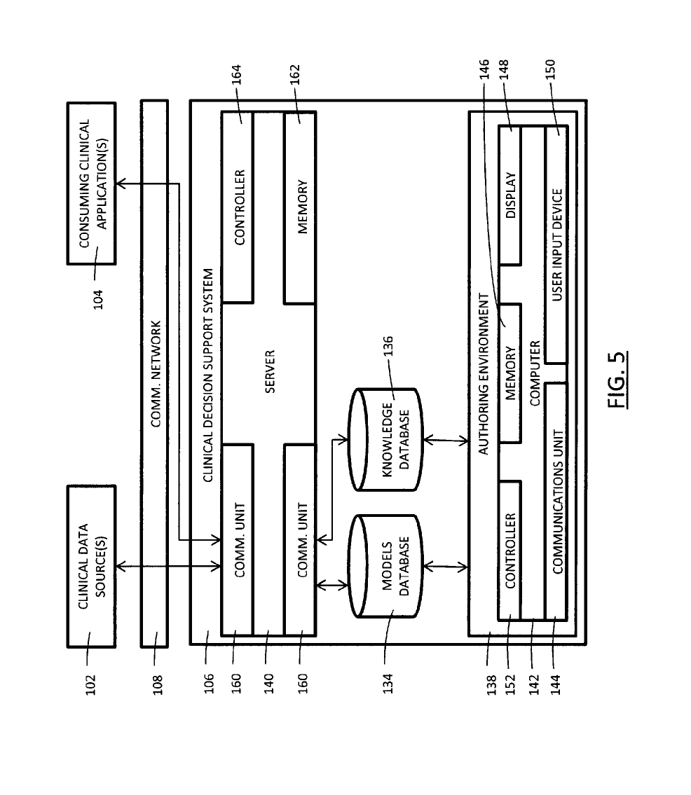

FIG. 5 is a structural view of a clinical decision support system according to aspects of the present disclosure; and,

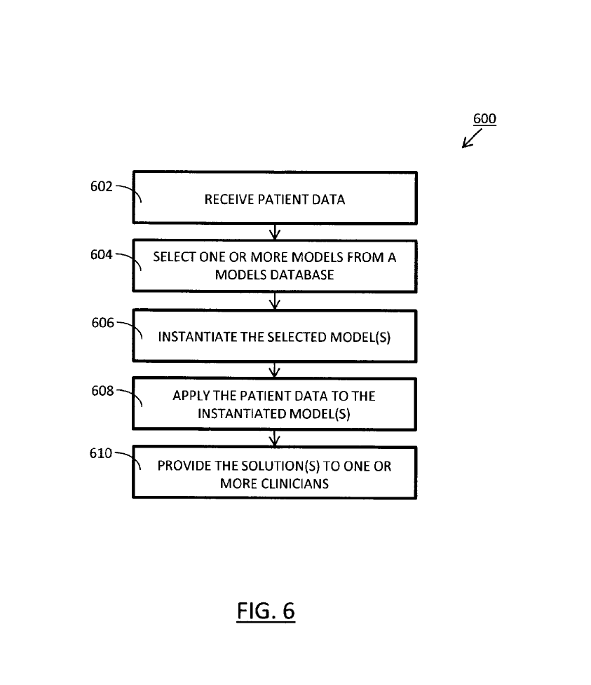

FIG. 6 is a method providing clinical recommendations to an end user according to aspects of the present disclosure.

With reference to FIG. 1, a block diagram of an information technology (IT) infrastructure 100 of a medical institution, such as a hospital, is provided. The IT infrastructure 100 includes one or more clinical data sources 102 (See FIG. 2), one or more consuming clinical applications 104 (See FIG. 3), a clinical decision support system (CDSS) 106, and the like. Suitably, the components of the IT infrastructure 100 are interconnected via a communications network 108, such as the Internet, a local area network, a wide area network, a wireless network, or the like.

The clinical data sources 102 provide patient data for associated patients to the CDSS 106. The patient data suitably includes clinical data collected during past and/or present encounters with patients, patient demographics, and the like. In certain embodiments, the clinical data sources 102 further support the selection of models by the CDSS 106. For example, in certain instances, the model selection engine 154 (see FIG. 2) utilizes data from one of the clinical data sources 102 to select a Bayesian network model for detecting hypoglycemia. Typically, the clinical data sources 102 provide the patient data when it first becomes available, but other events are contemplated, such as timer events, workflow events, and the like. The clinical data sources 102 suitably include at least one of: (1) one or more of one or more clinical devices 110; (2) one or more of one or more patient information systems 112; (3) other devices and/or applications generating patient data; and (4) the like.

The clinical devices 110 include one or more of end user terminals, peripheral clinical devices, patient monitors, devices at a patient bed or the clinician desktop, nursing stations, mobile communications devices, hospital-wide systems, workstations, displays, and the like, at various physical locations in the IT infrastructure 100. Each of the clinical devices 110 is typically associated with one or more patients and/or one or more clinicians. For example, a patient monitor attached to a patient and/or a clinician's workstation configured to receive clinical recommendations for a plurality of patients.

As illustrated, the clinical devices 110 include a patient monitor 110a, a therapeutic device 110b, and a medical imaging device 110c. Communications units 114 of the clinical devices 110 facilitate communication with external systems and/or databases, such as the CDSS 106, via the communications network 108. Memories 116 of the clinical devices 110 store executable instructions for performing one of more of the functions associated with the clinical devices 110. Displays 118 of the clinical devices 110 allow the clinical devices 110 to display data and/or messages for the benefit of corresponding users. User input devices 120 of the clinical devices 110 allow the corresponding users of the clinical devices 110 to interact with the clinical devices 110 and/or respond to messages displayed on the displays 118. Controllers 122 of the clinical devices 110 execute instructions stored on the memories 116 to carry out the functions associated with the clinical devices 110.

The patient information systems 106 include one or more of electronic medical record systems, departmental systems, and the like. The patient information systems 106 include one of more of a database 124, one or more server 126, and the like. The databases 124 store patient data of the institution. The servers 126 allow components of the IT infrastructure 100 to access the patient data via the communications network 108. Communications units of the servers 128 facilitate communication between the servers 126 and external devices, such as the clinical devices 110, via the communications network 108. The communications units 128 further facilitates communication with the databases 124. Memories 130 of the servers 128 store executable instructions for performing one of more of the functions associated with the servers 128. Controllers 132 of the servers 128 execute instructions stored on the memories 130 to carry out the functions associated with the servers 128.

The consuming clinical applications 104 receive clinical recommendations from the CDSS 106. Typically, the CDSS 106 provides the clinical recommendations when new patient data becomes available for a patient. However, it is contemplated that the CDSS 106 provides clinical recommendations in response to events other than the receipt of patient data, such as timer events, workflow events, and the like. The clinical recommendations typically include one or more of recommendations on a course of action or therapy based on the patient data, solutions to problems relevant to the patient data, and the like. To receive clinical recommendations for a patient, a consuming clinical application suitably registers with the CDSS 106 to receive clinical recommendations for the patient. The consuming clinical applications 104 suitably include at least one of: (1) one or more of the clinical devices 110; (2) one or more the patient information systems 112; (3) hospital information systems; (4) applications running on devices (e.g., PCs, cell-phones, etc.); and (5) the like.

The CDSS 106 receives patient data from one or more ones of the clinical data sources 102, such as one or more of the patient information systems 112, one or more of the clinical devices 110, one or more devices and/or applications generating patient data, and the like. The CDSS 106 then proceeds to analyze the patient data and provide results thereof to users and/or devices. Suitably, this analysis is performed with clinical knowledge modeled using one or more mathematical and/or computational methodologies. The clinical results typically include one or more of recommendations on a course of action or therapy based on the patient data, solutions to problems relevant to the patient data, and the like. The clinical recommendations are presented to users directly or indirectly via the consuming clinical applications 104, such as one or more of the patient information systems 112, one or more of the clinical devices 110, and the like. In certain embodiments, the consuming clinical applications 104 register with the CDSS 106 to receive to the results for the patient to which the results pertain. Additionally or alternatively, the consuming clinical applications 104 are automatically registered based on protocols, workflows, and the like local to the institution.

With reference to FIG. 2, a functional view of the CDSS 106 is provided. As illustrated, the CDSS 106 includes a models database 134, a knowledge database 136, an authoring environment 138, a server 140, and the like. However, other configurations are contemplated. For example, in certain embodiments, the authoring environment 138 is maintained by an outside vendor to develop models.

The models database 134 stores models embodying clinical knowledge pertaining to different clinical problems. As noted above, the models employ mathematical and/or computational methodologies to solve clinical problems and are stored using the standardized protocol. In certain embodiments, one or more of the models correspond to patient subpopulations. The knowledge database 136 stores rules facilitating the automatic or semi-automatic selection of one or more of the models to best analyze patient data. Suitably, the authoring environment 138 maintains the models database 134 and/or the knowledge database 136.

The authoring environment 138 facilitates the modeling of clinical knowledge in a computer interpretable format. As noted above, clinical knowledge is obtained through reading medical literature, mining patient data, consulting clinical experts, and the like. Typically, the models generated by the authoring environment 138 are generated to solve clinical problems, such as whether a patient is hypoglycemic. Further, in certain embodiments, it is contemplated that the models generated by the authoring environment 138 are generated for patient subpopulations. The models generated by the authoring environment 138 employ mathematical and/or computational methodologies to represent the clinical knowledge in a computer interpretable format. The methodologies include one or more of a Bayesian network, an artificial neural network, logistic regression, and the like.

To facilitate the modeling of clinical, in some embodiments, the authoring environment 138 provides developers with tools, graphical or otherwise, to model clinical knowledge using one or more mathematical and/or computational methodologies, such as a Bayesian network. In such embodiments, a standardized protocol is used to represent the models. In other embodiments, knowledge engineers and/or developers can use commercially available modeling software, such as Matlab, to model clinical knowledge in a computer interpretable format, and then use the authoring environment 138 to transform the model into the standard protocol. In such embodiments, the authoring environment 138 suitably includes tools, graphical or otherwise, to allow developers to transform models embodying clinical knowledge into the standardized protocol. For example, it allows clinical knowledge modeled using a Bayesian network in Matlab to be translated to the standardized protocol. Suitably, the standardized protocol is flexible enough to represent the clinical knowledge regardless of the particular mathematical and/or computational methodology used to model it.

The authoring environment 138 further facilitates the generation of rules for the automatic or semi-automatic selection of one or more models to best analyze patient data. A rule, in addition to selecting one or more models, implicitly identifies one or more problems to be solved, since models are generated for clinical problems. For example, it is contemplated that a rule specifies that if a patient's blood pressure data are in a certain range, a particular Bayesian model ought to be selected over a default logistic regression model. As is to be appreciated, the clinical problem in this example is whether the patient is at a risk for stroke. To facilitate the generation of the rules, it is contemplated that the authoring environment 138 includes tools, graphical or otherwise, allowing a developer to define match conditions and the models to select should a match occur.

Typically, a computer 142 embodies the authoring environment 138. However, more application specific devices, such as devices employing application-specific integrated circuits (ASICs), are contemplated. A communications unit 144 of the computer 142 facilitates communication other components of the CDSS 106. Further, the communications unit 144 facilitates communication with external systems and/or databases, consuming clinical applications 104, optionally via the communications network 108. A memory 146 of the computer 142 stores executable instructions for performing one of more of the functions associated with the authoring environment 138. A display 148 of the computer 142 allows the computer 142 to display a user interface allowing a user, such as a developer, to interact with the authoring environment 138. A user input device 150 of the computer 142 allows the user to interact with the user interface. A controller 152 of the computer 142 executes instructions stored on the memory 146 to carry out the functions associated with the authoring environment 138.

The server 140 of the CDSS 106 receives patient data from the clinical data sources 102, such as one or more of the patient information systems 112, one or more of the clinical devices 110, one or more devices and/or applications generating patient data, and the like. The server 140 then carries out the functionality of the CDSS 106, described in detail below.

Upon receiving patient data from one of the clinical data sources 102, a model selection engine 154 of the server 140 determines which one or more ones of the models within the models database 134 to employ to analyze the patient data. As noted above, the clinical data sources 102 include one or more of the patient information systems 112, one or more of the clinical devices 110, one or more other devices/applications generating patient data, and the like. Additionally or alternatively, upon the happening of a trigger event, such as a timer event, a workflow event, or the like, the model selection engine 154 similarly determines which one or more ones of the clinical models within the models database 134 to employ to analyze the patient data in, for example, one of the patient information systems 112.

In one form, the determination as to which ones of the models within the models database 134 to employ to analyze the patient data is made through application of one or more rules contained in the knowledge database 136. In another form, this determination is made through receipt of user input. For example, a user of the CDSS 106 specifies that a Bayesian network model for determining whether a patient's blood pressure is high is to be employed when analyzing the patient data. In yet another form, a hybrid of the foregoing forms is employed. For example, automatic selection is employed unless a user of the CDSS 106 overrides the automatic selection.

Regardless of the particular form employed to determine which of the models within the models database 134 to employ to analyze the patient data, the determination suitably considers one or more ones of a plurality of considerations. The plurality of considerations include the protocol and/or policy followed by the institution; the type of patient data (e.g., data pertaining to blood pressure), since this affects which clinical problems can be addressed therefrom; the patient, since it is contemplated the models are arranged by patient subpopulation in certain embodiments; the benefits and drawbacks of each mathematical and/or computation methodology used to model clinical knowledge for a clinical problem relevant to the patient data; whether a plurality of models can be selected for the clinical problem such that the advantages of one or more of these models makes up for limitations of one or more other ones of these models; whether the clinical problem is controversial, since it is contemplated that when the clinical problem is controversial, a plurality models embodying relevant clinical knowledge for the clinical problem are selected, thereby allowing users to toggle between the different models and compare the results; and the like. Based upon the determination of the models to employ to analyze the patient data, the model selection engine 154 collects the models from the models database 134 and presents them to a transformation engine 156 of the server 140. As noted above, the models are suitably represented using the standardized protocol.

The transformation engine 156 instantiates the models using information contained in the standardized protocol. For example, the transformation engine 156 parses the standardized protocol representations of the models to extract information therefrom and translates the extracted information to computer executable logic. In certain embodiments, the instantiated models include an abstraction layer facilitating uniform access thereto, regardless of the mathematical and/or computational methods employed thereby. Referring to FIGS. 3 and 4, graphical illustrations of the instantiation of clinical knowledge modeled using a Bayesian network 302 and an artificial neural network 402 are provided. FIGS. 3 and 4 further graphically illustrate an XML based embodiment of the standardized protocol 304, 404. The graphical illustrations are directed to a hypothetical problem of deciding whether a patient with stroke symptoms is a so-called stroke mimic.

In FIG. 3, the transformation engine 156 generates an instance of a model of clinical knowledge generated using a Bayesian network 302. As illustrated, the model is represented in the standardized protocol format 304. Among other things, the standardized protocol representation specifies the mathematical and/or computational methodology (i.e., Bayesian network), the input and output nodes, the values of the nodes, the relationships of nodes to one another (i.e., how they are connected), and the probabilities of the underlying conditional probability tables.

In FIG. 4, the transformation engine 156 generates an instance of a model of clinical knowledge generated using an artificial neural network 402. Notably, the instance 402 has a similar purpose as the instance 302 in FIG. 3. As illustrated, the model is represented in the standardized protocol format 404. Among other things, the standardized protocol representation specifies the mathematical and/or computational methodology (i.e., artificial neural network), the nodes of the input, hidden and output layers, their values, the relationships of nodes to one another, and the underlying weights.

In view of these graphical illustrations, it is to be appreciated that the standardized protocol captures the variables, parameters, and topography of models embodying clinical knowledge. That is to say, the standardized protocol captures the peculiarities of the different mathematical and/or computational methodologies used to model clinical knowledge. For example, the probabilities of Bayesian networks have an entirely different meaning than the weights of artificial neural networks; however, both are captured in a common rubric (“Parameters” in this example). The transformation engine 156 is provisioned to interpret the parameters based on the specification of the model type.

Referring back to FIG. 2, the instantiated models pass to a decision logic engine 158 of the server 140. The decision logic engine 158 applies the patient data to the instantiated models to determine solutions to the particular problem to which the models pertain. For example, in certain instances the patient data is applied to both a Bayesian network and an artificial neural network to determine whether the patient is hypoglycemic. As another example, in certain instances the patient data is applied to a Bayesian network to determine whether a patient is hypoglycemic and an artificial neural network to determine whether the patient has high blood pressure. In embodiments where the instantiated models include an abstraction layer, the decision logic engine 158 accesses the instantiated models through the abstraction layer.

After application of the patient data to the models, results thereto are provided to one or more ones of the consuming clinical applications 104. For example, the results are provided to a cell phone of a clinician associated with the patient. The results typically include the solutions to the clinical problems associated with to the instantiated models. However, it is contemplated that the solutions to the clinical problems associated with the instantiated models are further processed and the output of this further processing is provided as the results. Examples of further processing include one or more of thresholding, application of simplification rules, and the like. As noted above, in certain embodiments, the consuming clinical applications 104 register with the CDSS 106 to receive the results for the patient to which the results pertain. Additionally or alternatively, in certain embodiments, the consuming clinical applications 104 are automatically registered based on protocols, workflows, and the like local to the institution.

With reference to FIG. 5, a structural view of the CDSS 106 is provided. A communications unit 160 of the server 140 facilitates communication between the server 140 and external devices, such as the clinical devices 110. In certain embodiments, the communications unit 160 employs an asynchronous communication protocol, such as SOAP, XML over HTTP/TCP/IP, and the like, for communicating with the clinical devices 110 and other external devices. The communications unit 160 further facilitates communication with the models database 134 and the knowledge database 136 of the CDSS 106. A memory 162 of the server 140 stores executable instructions for performing one of more of the functions associated with the server 140. A controller 164 of the server 140 executes instructions stored on the memory 162 to carry out the functions associated with the server 140.

With reference to FIG. 6, a method 600 of providing clinicians with clinical recommendations based on patient data is provided. Patient data is received 602 from the clinical data sources 102, such as one or more of the patient information systems 112, one or more the clinical devices 110, one or more of devices and/or applications generating patient data, and the like. One or more models relevant to the patient data are then selected 604 from the models database 164. The models are stored using a standardized protocol and each solves a clinical problem. Further, the models are selected 604 based on user input or rules in the knowledge database 166. The selected models are instantiated 606 and the patient data is applied 608 to the instantiated models to determine solutions to the clinical problems associated with the instantiated models. The solutions are provided 610 to one or more clinicians. In certain embodiments, the clinicians registered to receive the solutions.

Each of the databases described herein, such as the models database 164, suitably include a computer database, where the computer database is embodied by a single computer, distributed across a plurality of computers, or the like. Further, each of the databases suitably stores data in a structured manner facilitating recall and access to such data. Further, as used herein, a memory includes one or more of a magnetic disk or other magnetic storage medium; a non-transient computer readable medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth. Further, as used herein, a controller includes one or more of a microprocessor, a microcontroller, a graphic processing unit (GPU), an application-specific integrated circuit (ASIC), a field-programmable gate array (FPGA), and the like; a communications network includes one or more of the Internet, a local area network, a wide area network, a wireless network, a wired network, a cellular network, a data bus, such as USB and I2C, and the like; a user input device includes one or more of a mouse, a keyboard, a touch screen display, one or more buttons, one or more switches, one or more toggles, and the like; and a display includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A clinical decision support system that provides clinical recommendations to one or more consuming clinical applications, such as patient information systems and clinical devices, based on patient data, said system comprising:
a models database that includes one or more models embodying clinical knowledge, wherein the models are stored using a standardized protocol and each solves a clinical problem, the clinical problem being whether a patient suffers from, or is at risk of, a physiological condition detrimental to patient health;
a model selection engine that selects one or more of the models relevant to the patient data;
a transformation engine that instantiates the selected models; and,
a decision logic engine that applies the patient data to the instantiated models to determine solutions to the clinical problems associated with the instantiated models, wherein the solutions are provided to the consuming clinical applications.

2. The clinical decision support system according to claim 1, wherein the instantiation includes parsing the standardized protocol for each of the selected models.

3. The clinical decision support system according to claim 1, wherein the selection is based on user input.

4. The clinical decision support system according to claim 1, further including:
a knowledge database that includes one or more rules for the selection of the one or more of the models relevant to the patient data; and,
wherein the selection is based on the rules.

5. The clinical decision support system according to claim 1, wherein the selected models include a plurality of the models, wherein each of the plurality of the models employs a different mathematical and/or computational methodology.

6. (canceled)

7. The clinical decision support system according to claim 5, wherein the mathematical and/or computational methodology employed by the each of the plurality of the models is one of a Bayesian network, an artificial neural network, and logistic regression.

8. (canceled)

9. A non-transitory computer readable medium carrying software which controls one or more processors to perform the functionality of the transformation engine and/or the decision logic engine of claim 1.

10. A method of providing clinicians with clinical recommendations based on patient data, said method comprising:
receiving patient data;
selecting one or more models relevant to the patient data from a models database, wherein the models are stored using a standardized protocol and each solves a clinical problem, the clinical problem being whether a patient suffers from, or is at risk of, a physiological condition detrimental to patient health;
instantiating the selected models;
applying the patient data to the instantiated models to determine solutions to the clinical problems associated with the instantiated models; and,
providing the solutions to one or more clinicians.

11. The method according to claim 10, wherein the instantiation includes parsing the standardized protocol for each of the selected models.

12. (canceled)

13. The method according to claim 1, wherein the selection includes applying one or more selection rules to the patient data.

14. The method according to claim 1, wherein the selected models include a plurality of the models, wherein each of the plurality of the models employs a different mathematical and/or computational methodology.

15. (canceled)

16. The method according to claim 14, wherein the mathematical and/or computational methodology employed by the each of the plurality of models is one of a Bayesian network, an artificial neural network, and logistic regression.

17. The method according to claim 1, wherein the patient data is received from one or more clinical data sources, such as patient information systems, and clinical devices.

18. One or more processors preprogrammed to perform the method according to claim 1.

19. A non-transitory computer readable medium carrying software which controls one or more processors to perform the method according to claim 1.

20. (canceled)
